(19) United States
(12) Patent Application Publication
(10) Pub. No.: US 2026/0369084 A1
(43) Pub. Date: Nov. 19, 2026

(54) METHODS FOR BIOLOGICAL VIDEO ANALYSIS

(71) Applicant: University of Kentucky Research Foundation, Lexington, KY (US)

(72) Inventors: Blaine Everett Weiss, Lexington, KY (US); Christopher Norris, Lexington, KY (US)

(21) Appl. No.: 19/680,670

(22) Filed: May 18, 2026

Related U.S. Application Data
(60) Provisional application No. 63/807,076, filed on May 16, 2025.

(51) Int. Cl. G06V 20/69; G06T 7/00; G06V 10/25; G06V 10/762; G06V 10/77; G06V 20/40

(52) U.S. Cl. CPC G06V 20/695; G06T 7/0012; G06V 10/25; G06V 10/762; G06V 10/77; G06V 20/44; G06T 2207/10016; G06T 2207/10056

(57) ABSTRACT

This disclosure is directed to machine learning-based methods including capturing a digital video of cellular structure and/or motion in one or more fields of view. The captured video is digitally filtered, and one or more regions of interest (ROI) are identified by a masking process to identify cell somas. The method has application in identifying and quantifying cell signaling events as well as identifying and quantifying arteriole movement.

### RELATED APPLICATIONS

This application claims priority to U.S. provisional patent application Ser. No. 63/807,076 filed on May 16, 2025, the entirety of the disclosure of which is incorporated herein by reference

### GOVERNMENT INTEREST

This invention was made with partial government support under grant number AG078116 awarded by the National Institute on Aging. The government has certain rights in the invention.

### TECHNICAL FIELD

The presently-disclosed subject matter generally relates to analysis of video captures of biological phenomena. In particular, certain embodiments of the presently-disclosed subject matter relate to a novel custom vascular modeling application for analysis of microscopy videos to identify and quantify activity of active cells and brain vasculature.

### BACKGROUND

Astrocytes are an essential component of the neurovascular unit. Chronically reactive astrocyte phenotypes are mechanistically linked to deleterious features of Alzheimer's disease (AD) including impaired cerebral blood flow, hypometabolism, and synapse dysfunction/loss. While cerebrovascular dysfunction and reactive astrocytosis are extensively characterized hallmarks of Alzheimer's disease (AD) and related dementias, the dynamic relationship between reactive astrocytes and cerebral vessels remains poorly understood.

Here, we used jGCaMP8f and two photon microscopy to investigate Ca²⁺ signaling in multiple astrocyte subcompartments, concurrent with changes in cerebral arteriole activity, in fully awake eight-month-old male and female 5×FAD mice, a model for AD-like pathology, and wild-type (WT) littermates. In the absence of movement, spontaneous Ca²⁺ transients in barrel cortex occurred more frequently in astrocyte somata, processes, and perivascular regions of 5×FAD mice. However, evoked arteriole dilations (in response to air puff stimulation of contralateral whiskers) and concurrent Ca²⁺ transients across astrocyte compartments were reduced in 5×FAD mice relative to WTs. Synchronous activity within multi-cell astrocyte networks was also impaired in the 5×FAD group. Using a custom application to assess functional coupling between astrocyte endfeet and immediately adjacent arteriole segments, we detected deficits in Ca²⁺ response probability in 5×FAD mice. Moreover, endfeet Ca²⁺ transients following arteriole dilations exhibited a slower onset, reduced amplitude, and lacked relative proportionality to vasomotive activity compared to WTs.

The results reveal nuanced alterations in 5×FAD reactive astrocytes highlighted by impaired signaling fidelity between astrocyte endfeet and cerebral arterioles. Reactive astrocytes in a fully awake mouse model of AD-like amyloid pathology are spontaneously hyperactive, exhibit impaired functional connectivity, and respond to dilations in immediately adjacent arterioles with poor fidelity. This reveals a key point of communication breakdown between the brain and the cerebrovasculature. These results have important implications for the mechanistic underpinnings of brain hypometabolism and the disruption of neurophysiological communication found in AD and other neurodegenerative conditions.

### SUMMARY

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

In one aspect of the disclosure, a method is described comprising capturing a digital video of cellular structure and/or motion in one or more fields of view, digitally filtering the video to accentuate cell features, eliminate Poisson noise, and correct unevenly illuminated fields of view, and identifying one or more regions of interest (ROI) in the one or more digitally filtered fields of view by a masking process comprising inputting normalized time series vectors and calculated signal parameters into a principal component analysis (PCA) to identify one or more PCA features.

The identified PCA features may be clustered to provide one or more activity clusters. The method further includes selecting one or more of the activity clusters showing an activity of interest, parsing the one or more selected activity clusters into pixel groupings by identifying connected pixels, and averaging time series data for the selected pixel groupings and inputting the averaged time series data into a signal analysis routine to provide one or more ROI signals. The one or more ROI signals may be processed by a continuous wavelet transformation and convolutional filtering, followed by determining a cell activity vector.

The method in embodiments further comprises detecting an event of interest by mirror padding the processed one or more ROI signals at signal start and end points, filtering the mirror padded one or more ROI signals, removing the mirror padded ends of the processed and filtered one or more ROI signals, inverting the signals, and acquiring local maximum and minimum signal amplitudes to index event peaks and signal start and end indices. In embodiments, another imaging channel may be applied to restrict signal clustering to an index of a channel of interest and surrounding space.

In embodiments, the method further includes setting boundaries of the channel of interest and modeling the boundaries using piecewise cubic hermite interpolating polynomials (PCHIP), and defining one or more perpendicular line functions to provide a plurality of images of the channel of interest cross-section. In embodiments, a further step of creating a binary mask of the channel of interest by adaptive thresholding is undertaken.

In another aspect, a method is provided comprising capturing a digital video of cellular structure and/or motion in one or more fields of view and digitally filtering the digital video to accentuate cell features, eliminate Poisson noise, and correct unevenly illuminated fields of view by steps of obtaining a motion signal associated with a time-series image dataset extracted from the digital video, thresholding the motion signal to identify one or more motion-associated time points, converting the thresholded motion signal to provide a binary motion trace, expanding each motion-associated time point over a predetermined temporal window defined by a selected number of digital video frames to provide one or more continuous motion associated time indices, and storing the one or more expanded motion-associated time indices as a motion index. The motion index is used to identify and/or exclude detected events that overlap motion-associated frames of the digital video frames to provide one or more uncontaminated motion-associated frames of the digital video.

The method further comprises detecting cellular events by generating an event map from the one or more uncontaminated motion-associated frames of the digital video. In embodiments, the one or more uncontaminated motion-associated frames of the digital video are conditioned by identifying one or more candidate signaling events from the event map by a multi-scale temporal detection process. In embodiments, the multi-scale temporal detection process comprises applying one or more of temporal filters, convolution kernels, wavelets, or matched filters to the event map. The multi-scale temporal detection process identifies one or more candidate signaling events having a distinctive temporal profile including one or more of a distinct rise time, a distinct decay time, a distinct full-width duration, a distinct onset slope, and a distinct transient shape. In embodiments, the event map represents one of the group consisting of: an event-likelihood trace, a convolution-derived response trace, a filtered response trace, and a time-dependent representation indicting a likelihood that a physiological event is present at each time point.

The method further comprises steps of signal analysis and pixel pre-classification to provide cell masks. In embodiments, the signal analysis and pixel pre-classification comprises inputting one or more normalized time series vectors and calculated signal parameters to provide a signal comprising a region-specific time-dependent trace identifying one or more regions of interest (ROI). The method further includes inputting the one or more normalized time series vectors and calculated signal parameters into a principal component analysis (PCA) to identify one or more PCA features. The one or more identified PCT features are clustered to provide one or more activity clusters.

Next, one or more of the activity clusters showing an activity of interest are selected and parsed into pixel groupings by identifying connected pixels. Averaged time series data of the selected and parsed pixel groupings are input into a signal analysis routine to provide one or more ROI signals. In embodiments, the one or more ROI signals are processed by a continuous wavelet transformation and convolutional filtering.

In embodiments, the cell activity vector may be determined according to:

$${\sum }_{i = 1}^{n} w {t ( i , : )}_{smoothed} * y ( i )$$

where:
n=number of convolutions;
wt=Wavelet Transform Matrix;
y=number of convolution outputs; and
i=event frequency iterator.

It will be understood that various details of the presently disclosed subject matter can be changed without departing from the scope of the subject matter disclosed herein. Furthermore, the foregoing description is for the purpose of illustration only, and not for the purpose of limitation

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The presently disclosed subject matter will be better understood, and features, aspects and advantages other than those set forth above will become apparent when consideration is given to the following detailed description thereof. Such detailed description makes reference to the following drawings, wherein:

FIG. 1. Segmentation of astrocyte sub compartments and spontaneous signal analyses in barrel cortex of awake mice. A, Two photon micrograph of a cerebral penetrating arteriole and surrounding capillary bed (red) and summated activity map of astrocyte Ca²⁺ signals (green). B, Activity feature map of signal properties (amplitude-red, variability-green, and shape-blue) represent the strength of each feature. Signal features for each pixel were inputted into an unsupervised learning algorithm and clustered to identify pixels composing active astrocyte compartments. C-D, Somata (C) and fine process (D) segmentation masks used for ROI signal extraction. E, Representative spontaneous Ca²⁺ traces extracted from individual soma compartments in FOVs from a WT and a 5×FAD mouse. Regions in red denote where individual Ca²⁺ transients were detected and measured. F-O, Scatterplots show Ca²⁺ transient parameters extracted from astrocyte somata (F-J) and processes (K-O) and averaged across FOVs for WT and 5×FAD mice. Parameters included: average number of Ca²⁺ transients per ROI (F,K), Ca²⁺ transient amplitude (G,L), rise time (H,M), total AOC (I,N) and decay (J,O). Each plot symbol represents an individual mouse. p values derived from two-tailed T tests.

FIG. 2. Air puff-evoked arteriole dilations in barrel cortex of awake mice. A, Mice received a 10 sec duration 9 Hz air puff train to the contralateral vibrissae. B-C, Pseudo-colored two photon micrographs showing penetrating arterioles, before (B) and during (C) air puff stimulation. D, Subtracted image of panels B and C showing the extent of vessel dilation (red arrows, green vessel segments) during air puff stimulation. E, Arteriole modeling and analysis protocol using LAVA application. F, Time plots showing representative arteriole diameter changes for WT and 5×FAD mice before, during, and after air puff stimulation (shaded rectangle). G, Raw arteriole cross sectional areas measured within each mouse at rest (circles) and during (squares) air puff stimulation. Basal arteriole diameter was comparable across genotypes, and both groups showed significant dilatory responses during air puff delivery [Baseline cross sectional area vs stimulation cross sectional area F (1,24)=69.3, p<0.001], though dilations were greater in the WT group [Interaction: F (1,24)=5.097, p=0.033]. H, Scatter plot shows percent arteriole dilation during air puff stimulation for both transgene groups. Each plot symbol represents an individual mouse. p values derived from two-tailed T tests.

FIG. 3. Astrocyte network activation and evoked signal analyses in awake mice. A, Individual Ca²⁺ events (shown in different colors) were extracted from unique ROIs in the FOV after whisker stimulation (gray rectangle). B, Temporal alignment of Ca²⁺ signaling events from unique ROIs. Each row represents Ca²⁺ events from a unique ROI (y axis). The * symbol exemplifies well synchronized events across ROIs, while the # symbol denotes poorly synchronized Ca²⁺ events across ROIs. C, Comparison of representative network diagrams of field astrocyte signal synchronization in a WT and 5×FAD mouse. Line colors represent Pearson's r correlation values. (Negative correlations not shown.) D-M, Scatterplots showing evoked astrocyte Ca²⁺ signaling parameters in WT and 5×FAD mice. Each plot symbol coefficients for all correlated ROI pairs (astrocyte somata, D; astrocyte processes, I) within the FOV. Ca²⁺ transient amplitude (E, J), rise time (F, K), AOC (G, L), and decay (H, I) were assessed in individual astrocyte compartments (somata D-H; processes I-M) and averaged within the in the FOV for each mouse. p values derived from two-tailed T tests. represents an individual mouse. Network synchronicity (D, I) reflects the average Pearson correlation.

FIG. 4. Perivascular astrocyte Ca²⁺ events in awake mice. A, Two photon micrograph of cerebral vessels (red) and summated activity map of astrocyte Ca²⁺ signals (green). B. Mask of perivascular regions (white) for Ca²⁺ event extraction. C. Representative Ca²⁺ traces extracted from perivascular ROIs. In the left panel, regions in red denote where individual Ca²⁺ transients were detected and measured. In the right panel, extracted Ca²⁺ events from unique ROIs were temporally aligned for network analyses, as described in FIG. 3B. D-H, Scatterplots for spontaneous perivascular Ca²⁺ transient parameters including the average number of transients/ROI (D), amplitude (E), rise time (F), AOC (G), and decay (H). I-M, Scatterplots for air puff-evoked perivascular Ca²⁺ transient parameters including correlated activity across all endfeet pairs in the FOV (I, Network synchronicity as described in FIG. 3), and average Ca²⁺ transient amplitude (J), rise time (K), AOC (L), and decay (M) in individual perivascular ROIs within the FOV. Each plot symbol represents an individual mouse. p values derived from two-tailed T tests.

FIG. 5. Spatial-temporal analyses of vascular-astrocyte endfeet activity by LAVA application. A. Cartoon illustration showing analyses of astrocyte endfeet pairings within individual arteriole segments (blue lines) during airpuff-induced dilations (white arrows). B, Two photon micrograph of a cerebral penetrating arteriole (red) and summated activity map of astrocyte Ca²⁺ signals (green). C, Modeling and sampling of arteriole crosssections are used to produce linearized channel clips containing the vessel of interest (white) and perivascular spaces (Ca²⁺ activity in green). Vascular tone is measured from cross sectional area measurements, as well as close capture of astrocyte endfeet (1 and 2). D, Same FOV shown in panel B assessed during whisker stimulation. Endfoot ROIs (1 and 2 pink) and vascular mask (white) determined from the linearized vessel model (panel C) are mapped onto raw channels. E, Measurements of vascular tone from linearized model in panel C and Ca²⁺ levels recorded from each endfoot (1 and 2) in panel D are plotted to display temporal associations of field activity. F-G, Pie charts showing the functional make-up of endfeet-arteriole pairings for WT (F) and 5×FAD (G) mice. Red indicates arteriole dilations with a subsequent endfoot Ca²⁺ response; Blue indicates arteriole dilations in the absence of an endfoot response; Yellow indicates endfoot Ca²⁺ response in the absence of an arteriole dilation; Black indicates pairings with neither an arteriole dilation, nor an endfoot Ca²⁺ response. H, Scatter plots showing the endfoot Ca²⁺ response latency (i.e. latency between initial stimulation induced vasodilation and subsequent endfoot Ca²⁺ signals). I, Scatterplot shows evoked Ca²⁺ transient amplitudes in arteriole-associated endfeet. J, Scatterplots show the proportional relationship between Ca²⁺ transient amplitude in each endfoot relative to vessel cross sectional area in the immediately adjacent arteriole. In H and J, each plot symbol represents an individual endfoot-arteriole pairing. In I, each plot symbol represents an individual mouse. p values derived from two-tailed T tests.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

The presently-disclosed subject matter describes in certain embodiments machine-learning based methods for analysis of video captures of biological processes. In particular, the machine learning-based methods find applications in measuring vascular activity. Advantageously, the methods perform analysis by cell identification rather than simply quantification of regions of activity.

In embodiments, the described machine learning-based methods comprise application of algorithms adapted to divide video capture pixels into active/inactive regions, and to cluster cells down to subcellular compartments. The algorithm comprises filtering functionalities that correct for brightness differences from uneven test subject head orientation, and that enhance contrast.

In embodiments, the algorithms include functionalities to identify different cell activation events, quantify signal properties of those events, and correlate with other cells in the field of view as well as with cerebrovasculature activity.

In embodiments, the machine learning-based methods comprise application of algorithms adapted to model active vasculature vessels for activities such as change in diameter, and to map intravessel chance in diameter. The algorithms are capable of identifying specific regions on vessels such as arterioles undergoing size changes, and of measuring activity of cells in that area such as astrocytes.

In particular embodiments, the described machine learning-based methods are adapted for identification and quantification of astrocyte activity by functional compartments. Certain compartments such as endfeet have specialized activity at the neurovascular unit, and the directionality of this activity in relation to vascular tone regulation is poorly understood. By the described machine learning-based methods, it is possible to precisely evaluate activity of multiple cell compartments and quantify relationships between compartments, as well as relationships between cell compartments and vascular activity. The described techniques are applicable to all cells in the neurovascular unit.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

As and if used herein, the terms “treatment” or “treating” refer to the medical management of a subject with the intent to cure, ameliorate, reduce, or prevent a condition. As will be recognized by one of ordinary skill in the art, the term “cure” does not refer to the ability to completely remove all excess lipid accumulation in a target area. For example, in some embodiments, a cure can refer to a decrease at a level of 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% decrease. Similarly, as will be recognized by one of ordinary skill in the art, the term “prevent” does not refer to an ability to completely prevent any and all symptoms.

Likewise, as will be recognized by one of ordinary skill in the art, the term “inhibiting” or “inhibition” does not refer to the ability to completely inactivate all target biological activity in all cases. Rather, the skilled artisan will understand that the term “inhibiting” refers to decreasing biological activity of a target, such as NR4A1. Such decrease in biological activity can be determined relative to a control, wherein an inhibitor is not administered and/or placed in contact with the target. For example, in some embodiments, a decrease in activity relative to a control can be about a 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% decrease.

The terms “subject” or “subject in need thereof” may refer to a target of administration, which optionally displays symptoms related to a particular disease, pathological condition, disorder, or the like. The subject of the herein disclosed methods can be a mammal. Thus, the subject of the herein disclosed methods can be a human, non-human primate, horse, pig, rabbit, dog, sheep, goat, cow, cat, guinea pig, or rodent. The term does not denote a particular age or sex. Thus, adult and newborn subjects, as well as fetuses, whether male or female, are intended to be covered. A patient refers to a subject afflicted with a disease or disorder. The term “patient” includes human and veterinary subjects.

The term “effective amount” refers to an amount that is sufficient to achieve the desired result or to have an effect on an undesired condition. For example, a “therapeutically effective amount” refers to an amount that is sufficient to achieve the desired therapeutic result or to have an effect on undesired symptoms, but is generally insufficient to cause adverse side effects. The specific therapeutically effective dose level for any particular patient will depend upon a variety of factors including the disorder being treated and the severity of the disorder; the specific composition employed; the age, body weight, general health, sex and diet of the patient; the time of administration; the route of administration; the rate of excretion of the specific compound employed; the duration of the treatment; drugs used in combination or coincidental with the specific compound employed and like factors well known in the medical arts. For example, it is well within the skill of the art to start doses of a compound at levels lower than those required to achieve the desired therapeutic effect and to gradually increase the dosage until the desired effect is achieved. If desired, the effective daily dose can be divided into multiple doses for purposes of administration. Consequently, single dose compositions can contain such amounts or submultiples thereof to make up the daily dose. The dosage can be adjusted by the individual physician in the event of any contraindications. Dosage can vary, and can be administered in one or more dose administrations daily, for one or several days.

Any and all patents, patent applications, published applications and publications, GenBank sequences, databases, websites, non-patent literature, and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

As and if used herein, the abbreviations for any protective groups, amino acids, nucleotides, and other compounds, are, unless indicated otherwise, in accord with their common usage, recognized abbreviations, or the IUPAC-IUB Commission on Biochemical Nomenclature (see, Biochem. (1972) 11 (9): 1726-1732).

Although any methods, devices, and materials similar or equivalent to those described herein can be used in the practice or testing of the presently-disclosed subject matter, representative methods, devices, and materials are described herein.

Nucleotides and polypeptides disclosed herein, if any, are included in publicly-available databases, such as GENBANK® and SWISSPROT. Information including sequences and other information related to such nucleotides and polypeptides included in such publicly-available databases are expressly incorporated by reference. Unless otherwise indicated or apparent the references to such publicly-available databases are references to the most recent version of the database as of the filing date of this Application.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

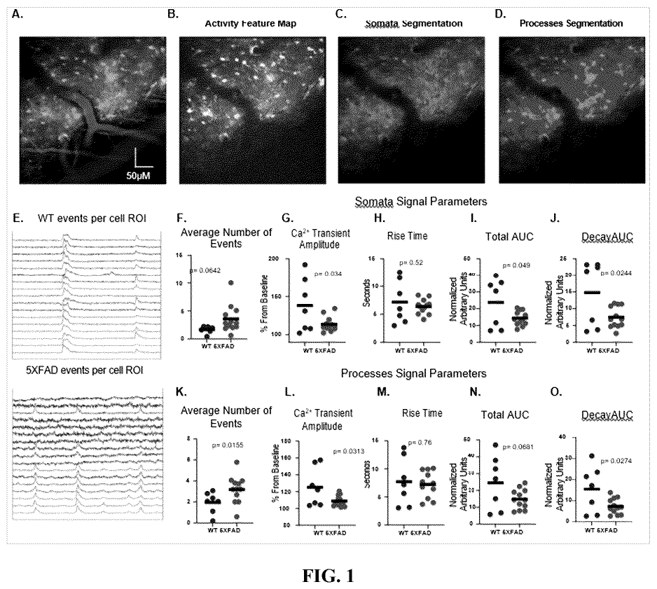

In one embodiment, with reference to FIG. 1 the described method applies steps of motion correction and downscaling to captured microscopy videos. Next, the algorithm applies steps of image modeling and convolutional filtering. A custom filter tool is used to apply digital filters in Fourier space. Existing filter design accentuates the features of cells, while eliminating Poisson noise, and correcting unevenly illuminated fields of view. In certain embodiments, the system receives or accesses a motion signal associated with the time-series image dataset. The motion signal may represent frame-to-frame motion, displacement, motion correction output, artifact detection output, or another temporal indicator of motion-associated contamination.

The system may threshold the motion signal to identify motion-associated time points. The thresholded motion signal may be converted into a binary motion trace in which time points meeting or exceeding the motion criterion are assigned a motion associated state. The system may then expand each motion associated time point over a temporal window. The temporal window may be determined from the acquisition rate, such as by expanding each detected motion time point over a selected number of subsequent frames, thus providing continuous motion associated time indices.

The expanded motion associated time indices may be stored as a motion index. In some embodiments, the motion index is used to flag, suppress, exclude, or remove detected events that overlap motion associated frames. This allows the event extraction procedure to optionally reject events likely to be contaminated by image motion, movement artifacts, or motion-associated changes in fluorescence intensity.

In some embodiments, the system detects events by generating an event map from each region-specific trace. The system may first condition the trace by applying temporal filtering, detrending, normalization, or signal shifting. In one embodiment, a low-pass Butterworth filter is applied to the region-specific trace. The filtered signal may be detrended and shifted relative to its minimum value to generate a non-negative detection signal.

The system identifies candidate signaling events using a multi-scale temporal detection procedure. The system may apply a plurality of temporal filters, convolution kernels, wavelets, or matched filters to the normalized signal. Each filter may be configured to preferentially detect events having a different temporal profile, including but not limited to different rise times, decay times, full-width durations, onset slopes, or transient shapes.

In certain embodiments, the system uses a matched filter bank comprising a plurality of kernels having biologically plausible transient shapes. For example, each kernel may approximate a calcium transient using a difference of exponentials, exponential rise and decay function, asymmetric rise-decay waveform, Gaussian-modulated waveform, cosine-derived waveform, or another parametric or empirical event template. Each kernel may be normalized, including by subtracting its mean, scaling to unit energy, or otherwise standardizing its response magnitude, such that responses across kernels are comparable.

The system may convolve each region-specific signal with the plurality of kernels to generate a corresponding plurality of filter response traces. In some embodiments, the filter responses are robustly scaled to produce a signal to noise like score for each time point and each temporal scale. The system may then combine the responses across the filter bank by selecting the maximum response, a weighted sum, an energy-weighted combination, a frequency-weighted combination, or another aggregate score representing the likelihood that an event is present at each time point.

The conditioned signal may then be processed to generate an event map. The event map may represent an event-likelihood trace, convolution derived response trace, filtered response trace, or other time-dependent representation indicating the likelihood that a physiological event is present at each time point. The event map may be generated separately for each selected region of interest. The resulting event map is used as the basis for subsequent event segmentation.

Next are steps of signal analysis and pixel pre-classification. The technique is used non-destructively for the purpose of obtaining cell masks. Masking for cell somas is performed by inputting normalized time series vectors, and several calculated signal parameters into a principal component analysis for dimension reduction. The first four components are used for activity clustering and ROI formation. The resulting signal comprises a region specific time-dependent trace. In one embodiment, the system fills missing values in the extracted trace by interpolation to generate a preserved trace. The preserved trace may be stored for later event waveform extraction, event metric calculation, visualization, or manual event review. The system may also generate a conditioned trace from the preserved trace. In some embodiments, the conditioned trace is smoothed according to the acquisition rate of the image sequence, or one selected in application. The preserved trace and conditioned trace may be maintained separately, such that one trace is available for preserving measured signal values while another trace is available for event detection, filtering, or display.

For region of interest (ROI) formation, PCA features obtained are clustered using the k-means clustering algorithm at 500 iterations. Three clusters were determined to be the optimal number of clusters by elbow method. The results of the activity clustering are displayed to the user, where the mode of activity of interest can be selected. The desired cluster is then parsed into groupings of pixels by determining pixels within the selected cluster that are connected. The groupings are then labeled. Groupings that are smaller than 3 pixels are then excluded. The groupings are then relabeled, and pixel boundaries dilated by convolution. A hole fill function is applied, and then the groupings are relabeled one more time. Misjoined groupings can be corrected via a splitting tool in the graphical user interface. To use it, the user simply selects the tool, and then draws a line through the region to be split. The ROIs are then updated with the additional ROIs added.

For ROI signal spectral analysis, time series data is averaged for pixels comprising the mask and input into a two-part signal analysis routine. ROIs signals are processed using continuous wavelet transform with the Amor wavelet and reconstructed at relevant frequency range (minimum to max 13 hz for astrocytes) For event detection, the signal is then analyzed using CWT between 0.05 and 0.5 hz. CWT coefficients are smoothed by moving sum across the time dimension, and coefficients less than 10% of total power are excluded. The results are used as an index for the previously reconstructed wavelet transform.

Next the ROI signal is processed for convolutional filtering. First the ROI signal is filtered using a Butterworth filter and detrended. Then a mirror padded convolution is performed on the ROIs' signals and then normalized. Values below-0.5 standard deviation are excluded to isolate potential peaks of cell activity.

A cell activity vector is determined by the product of the two:

$${\sum }_{i = 1}^{n} w {t ( i , : )}_{smoothed} * y ( i )$$

Where:

| Variable | Definition |
|---|---|
| n | Number of convolutions |
| wt | Wavelet Transform Matrix |
| y | Convolution Outputs |
| i | Event frequency iterator |

Finally, results are then normalized by z-score and values below 0.5 standard deviations are set to 0. All positive values serve as a preliminary event index. The results represent significant activity by varying event durations. The relative power of an event of particular size (i) weights its contribution in the result, thereby providing tolerance for the detection of events which vary in amplitude, and duration, commonly observed in biological entities.

In certain embodiments, the disclosed method further incorporates a frequency-domain or time-frequency-domain weighting procedure to improve event detection. The system may compute a continuous wavelet transform, short-time Fourier transform, multi-resolution spectral decomposition, or another time-frequency representation of the extracted signal. The resulting spectral or wavelet power may be evaluated over a plurality of frequency bands corresponding to expected biological event durations.

For example, relatively slow calcium transients may be represented by lower-frequency components, while shorter-duration transients may be represented by higher-frequency components. The system may use the time-frequency representation to generate one or more temporal weighting functions corresponding to candidate event sizes or durations. These weighting functions may be used to modulate, weight, gate, or rank the responses of the temporal filter bank.

In one embodiment, each event scale is associated with a corresponding frequency or frequency band, and the wavelet power at that frequency or band is used to weight the matched filter response for the corresponding temporal kernel. In this manner, the system may enhance event candidates whose temporal morphology and spectral content are concordant, while suppressing noise fluctuations or artifacts that do not exhibit coordinated time-domain and frequency-domain evidence of a biological transient.

In some embodiments, the weighting is not based on a global average frequency power across the full recording, but is instead calculated locally in time. This permits detection of transient events occurring at event sizes or durations that may be sparsely represented in the recording. The system may thereby avoid attenuation of rare but biologically meaningful events that would otherwise be suppressed by global frequency averaging.

The data are then processed for event detection and signal measurements, and used for network synchronicity testing and spatial statistics.

For event detection, such as identifying astrocyte calcium signals, the ROI signal is mirror padded at the start and end points and then filtered using a 5th order low pass Butterworth filter from Nyquist to 1 hz. The padded ends are removed, the signal inverted, and local maximum and minimums are acquired to index event peaks, as well as start and end indices. The transient amplitude, area under the curve, and rise and decay times are then calculated and GUI updated. The user can then review the output of the event detection for each ROI and make manual corrections where impulse noise, local cell signal interference, or other artifactual contamination impacted accurate event indexing. In certain embodiments, the system converts the aggregate event likelihood score into discrete event segments using a dual-threshold or hysteresis procedure. A first threshold may define a high confidence event core window, while a second lower threshold may define the temporal extent of the event. Candidate events may be initiated when the event likelihood score exceeds the higher threshold and extended backward and forward until the score falls below the lower threshold, until a baseline crossing is reached, or until another termination criterion is satisfied.

The method may further impose constraints on candidate events, including minimum event duration, maximum event duration, minimum inter event or edge guard interval, merge gap between adjacent events, minimum peak prominence, minimum area under the curve, minimum slope, maximum artifact score, or combinations thereof. Adjacent candidate segments may be merged when separated by a temporal gap shorter than a predefined or adaptive interval. Candidate segments may be rejected if they fail to satisfy one or more quality control criteria.

This hysteresis-based segmentation allows the system to detect events with variable amplitudes and durations while reducing fragmentation of single biological transients into multiple detected events. It also reduces false detections caused by brief threshold crossings or noise spikes.

In some embodiments, the initially detected event boundaries are refined using features of the original or normalized signal. The onset may be adjusted to the beginning of a rising phase, a local baseline crossing, a local minimum preceding the peak, a slope change point, a derivative threshold crossing, or a point determined by fitting a transient model to the signal. The peak may be identified as the maximum value of the signal, maximum filter response, a maximum normalized activity, or maximum model estimated transient amplitude within the event window. The offset may be adjusted to a decay phase baseline crossing, lower threshold crossing, derivative stabilization point, or another signal defined endpoint.

After event segmentation, the system may convert detected event segments into labeled event indices. Each labeled event index may identify the frames belonging to a corresponding event. The system may reconstruct event bounds from the labeled event indices by identifying the first and last frame associated with each event label.

For each labeled event, the system extracts an event specific waveform from the corresponding region specific trace. The event specific waveform may comprise a two column array or paired data structure/dictionary containing frame indices and corresponding signal values. The event specific waveform may be stored in an event plot data structure indexed by region of interest and event number.

In certain embodiments, the extracted waveform is stored both as a local trace fragment and as an application level event record. The system may also generate trace access numbers identifying the detected events associated with each region. These trace access numbers may be used to navigate, display, edit, delete, or otherwise interact with detected events.

In some embodiments, event refinement is performed separately for each region of interest, thereby accommodating heterogeneity in signal kinetics across cellular compartments, vascular regions, or imaging depths. The refined event boundaries may be used to compute event metrics including amplitude, duration, rise and decay time, fit parameters such as exponential decay constant, etc.

For correlational analysis, correlations between discrete values are performed via Pearson's r. For correlating the timing/synchronicity of cells within the field of view, Pearson's r is calculated between pairs of ROI's event indices. The distance between ROIs is also calculated, and used to determine the distance to synchronicity correlation. Finally, a correlation between a cell ROIs synchronicity and amplitude of the signal can also be extracted.

In some embodiments, the extracted event data are used to construct functional association maps among regions of interest. The system may compare event timing, event co-occurrence, event overlap, event triggered lag, correlation during event windows, or normalized signal similarity across pairs of regions. The resulting pairwise measures may be used to generate adjacency matrices, directed lag matrices, recruitment probability matrices, correlation distance matrices, or graph representations of functional network structure.

In other embodiments, the methods may include determination of perivascular segmentation. In particular embodiments, the methods optionally utilize a second imaging channel to quantify activity in an area surrounding the ROI. One example is imaging cerebrovasculature. To analyze activity in the vascular and perivascular space, this channel is used to mask and thereby restrict signal clustering to the index of the channel of interest and its surrounding space. A mask is taken of the channel of interest (vasculature) and dilated to a user defined distance. Filtering of the masking channel can be used to correct for unlevel imaging surfaces. The resulting mask is then applied to the channel containing the signals of interest. The remaining signals are then input as described previously into the signal classification algorithm.

In still other embodiments, after segmentation the user may select an option for an in-depth analysis of the masking channel. This opens an application called LAVA (Localized Analysis of Vascular Astrocytes) which is configured to determine the directionality of signals to vascular tone changes, and determine the correlation of their magnitude. This is especially useful for the evaluation of vascular-cell signaling dynamics in the context of stimulation.

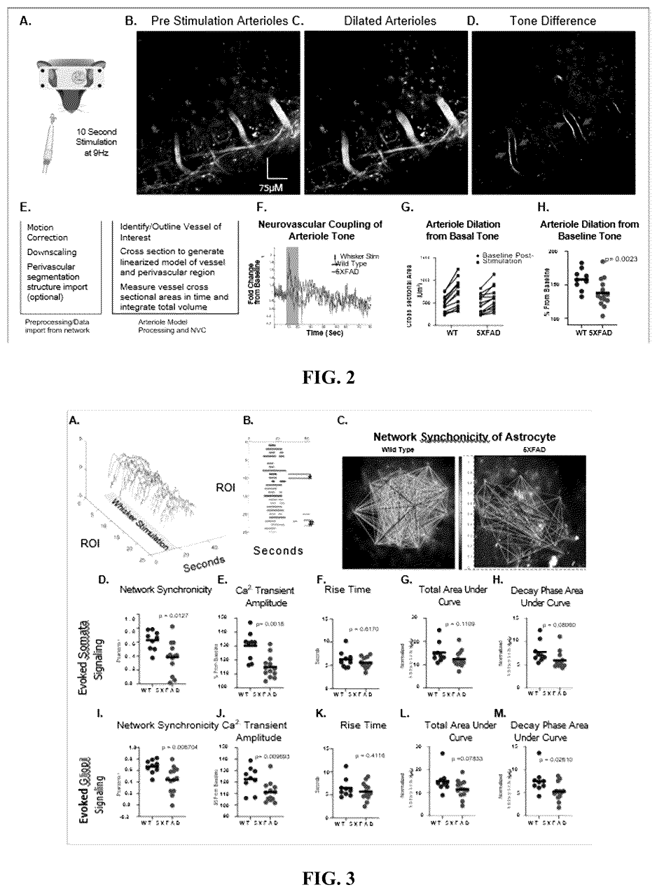

In more detail and with reference to FIG. 2, LAVA automatically imports channels, and relevant metadata into its workspace. The protocol begins with user selection of the rough boundaries of a vessel of interest by clicking draw points over the vessel walls. The vessel boundaries are then modeled using piecewise cubic hermite interpolating polynomials (PCHIP), and perpendicular cross-sectional line functions are made to section the vessel. Once completed, the user is prompted to enter the perivascular distance from which the lines will be extended from the vessel. The vessel image stack is then resampled using pixel values along the cross-section line functions to create a pseudo image stack of the linearized vessel and its perivascular space.

Next, a binary mask of the vessel of interest is made by using adaptive thresholding performed over the pseudo image stack. The mask is then used to index the vessel on the raw image stack. Cross sections with duplicate pixels in their index are removed, and the remaining cross sections are used to calculate cross section diameters. A calculated volume measurement is also made and time series arrays are output. The time series is optionally normalized by a user set baseline time period for use in stimulation time series experiments.

Vessel segments that dive axial to the imaging plane have reduced signal intensity to background ratios introducing artifact small vessel cross segments. Random jumps in calculated vessel center line, and cross-sectional diameter, in addition to absent measurements are flagged for exclusion for volume, and pairwise activity comparisons. A user defined tolerance for invalid cross section time point counts are used to either completely remove segments, or attempt missing value interpretation for cross section diameter. Flagged invalid regions may be stored as additional regions of interest and is intended for cases where interesting structures, or vessel branch points contaminate clear vascular structures.

The remaining fluorescence channels can be analyzed for activity in the vascular and perivascular space, using the models and data calculated previously. The pseudo image stack is used to make user defined regions of interest that lie over and/or immediately adjacent to the vessel. The mask is transformed back to the fluorescence channel image stack for pixel value extraction and time series array creation. The cross-section line functions and calculated vessel diameter data that were used to calculate vessel motion are used to correct for perivascular feature movement along the vector of vessel motion. Segments of user defined ROIs that overlap the vessel of interest maintain their position over the vessel. This allows for precise measurement of narrow moving, expanding, and/or shrinking regions of interest around objects of interest. In our example, the technique was used to quantify the activity of astrocyte endfeet. The event extraction method is integrated with a vascular or perivascular analysis module. The system may extract time dependent vascular features such as vessel diameter, wall displacement, lumen area, cross-sectional intensity, centerline motion, arteriole pulsatility, vasodilation, vasoconstriction, or vascular tone. These vascular signals may be processed using similar baseline correction, filtering, event detection, and boundary-refinement procedures.

Using the vascular motion and astrocyte endfeet time series arrays, the functional connectivity between the two can be determined for the experimental trial. Correlations of the magnitude, and the latency between the two, as well as from other segmentations established by STONE can be extracted by the user. Additionally, intravascular comparisons can be made point by point along sections of the vessel and immediately adjacent perivascular space to identify regions where elevated or diminished cell activity may correlate with vascular motion. This is particularly useful for experiments utilizing optogenetics/photo stimulation of cells, and for vascular and/or perivascular cell damage experiments via laser ablation.

The system may associate cellular or astrocytic events with vascular events by temporal proximity, spatial proximity, overlap with perivascular regions, event onset lag, peak lag, cross-correlation, event-triggered averaging, or directed recruitment analysis. In one embodiment, events detected in endfoot or perivascular regions are linked to vascular diameter or motion changes occurring within a defined temporal window. The system may then quantify coupling metrics, including event-triggered vascular response amplitude, latency, correlation strength, probability of vascular response following cellular activation, and directionality of the association.

Once all prior segmentations have been obtained and saved, the user may utilize existing masks to quantify signaling that occurs in diffuse areas or around the outer edges of morphologically distinct ROIs. After masking out all prior segmentations, the pixel classification algorithm is run one more time to identify the remaining signal in the field of view. Event detection and indexing is carried out as described previously.

Likewise, once all prior segmentations have been obtained and saved, intercompartment or intermodal analysis may be conducted. Matrices of ROI activity metrics are used to conduct these comparisons. For example, a first matrix may represent the strength of temporal association between pairs of regions, while a second matrix represents the estimated time lag or directionality of recruitment. The system may further compute graph theoretic metrics including node degree, weighted degree, global efficiency, local efficiency, path length, clustering coefficient, modularity, community structure, or spectral cluster membership. LAVA acquired vascular event metrics may be compared with activity of other field segmentations. These metrics may be used to characterize spatially distributed and identity relevant, physiological signaling networks.

The presently-disclosed subject matter is further illustrated by the following specific but non-limiting examples. The following examples may include compilations of data that are representative of data gathered at various times during the course of development and experimentation related to the present invention.

### Examples

The neurovascular unit, comprised of cerebral blood vessels and multiple neural cell types is essential for promoting brain health (1, 2). Chronic neurodegenerative diseases like Alzheimer's disease (AD) are characterized by pathognomonic proteinaceous deposits that occur alongside cerebrovascular dysfunction and hypometabolism (3). Most of the cerebral vasculature is ensheathed by astrocyte endfeet specializations, while other astrocyte processes are in direct contact with many, if not most, excitatory synapses (4, 5). Astrocytes also contain the requisite machinery for taking up, processing, and releasing metabolites, and therefore represent a critical cellular liaison between blood and brain. In the course of AD and related dementia disorders (ADRDs), astrocytes become reactive and exhibit complex loss- and gain-of-function phenotypes (6-8). These clues have led us and others to hypothesize that astrocytes play key roles in the deleterious cerebrovascular phenotypes of chronic neurodegenerative conditions (6, 9-11).

Recent studies have investigated Ca²⁺ signaling as a proxy for the altered function of reactive astrocytes in AD/ADRD mouse models (12-19). Findings have been mixed with some reports showing augmented Ca²⁺ signaling in AD mouse models, characterized by elevations in spontaneous Ca²⁺ transient frequencies and amplitudes, while others have shown no change or reductions in these parameters. To date, only a few reports on intact AD/ADRD mouse models have described Ca²⁺ signaling in the endfeet (13, 14, 17), which are the most proximal astrocyte subcompartments relative to the cerebral blood vessels. In these studies, endfeet Ca²⁺ was either assessed in the absence of concurrent vascular measures (13), or during the administration of general anesthesia (14, 17), which can greatly suppress astrocyte signaling and/or alter vascular tone during brain stimulation (20, 21).

Here, we used the genetically-encoded Ca²⁺ indicator jGCaMP8f and intravital two photon microscopy to investigate astrocyte Ca²⁺ transients in multiple cellular compartments of fully awake 5×FAD mice (characterized by robust parenchymal brain amyloid pathology) and age-matched wild type littermates. Astrocyte Ca²⁺ signaling in individual subcompartments and astrocyte networks, concurrent with dynamic responses in penetrating arterioles, was assessed in the barrel cortex at rest and during air puff whisker stimulation of the contralateral vibrissae. Using a novel custom vascular modeling application, Localized Analysis of Vascular Astrocytes (LAVA), we also directly assessed temporal and proportional relationships between astrocyte endfeet Ca²⁺ transients and immediately adjacent arteriole segments. Our findings describe novel (dys) functional phenotypes of reactive astrocytes and may offer new insights into how energy coupling breaks down during AD and related dementias.

### Materials and Methods

Mice. Male and female 5×FAD and wild type (B6-SJL) mice were purchased from The Jackson Laboratory (Cat #) and bred to produce hemizygous and littermate control F2 mice. Mice were housed in standard laboratory cages (IVC) under 12 h light/dark cycles in a pathogen-free environment in accordance with University of Kentucky guidelines. Mice had access to food and water ad libitum. All animal procedures were conducted in accordance with the National Institutes of Health Guide for the Care and Use of Laboratory Animals and were approved by University of Kentucky Institutional Animal Care and Use Committees.

Adeno-associated virus (AAV) reagents. cDNAs for jGCaMP8f (22) were encoded in vectors downstream of the human GFAP promoter (GFA104 ABCD9). Plasmids were sent to Charles River Laboratories for packaging into AAV2/5 capsids. When injected into adult mice, AAV-GFA104 vectors drive expression of target transgenes selectively in astrocytes. Mice were injected with AAV2/5-GFA104-JCaMP8f into barrel cortex (see below) at approximately six months of age to detect and quantify astrocytic Ca²⁺ transients.

AAV injection and cranial window implantation. Surgical techniques were performed as described in our previous studies (12, 23) with some modifications. Briefly, mice were anaesthetized by 3% isoflurane (SomnoSuite, Kent Scientific) in an induction box and head-fixed to a stereotaxic frame. Anesthesia was maintained by continuous isoflurane inhalation (1.5-3%, via nose cone) during surgery. The injection was marked over the barrel cortex at 1.5 mm AP, ±3 mm ML. The injection site was used as the center point of a 3 mm diameter craniotomy for cranial window implantation. The freed circular skull fragment was carefully removed with tweezers. AAV (1013 IFU/mL) was delivered at a rate of 0.2 μL/min (total 2 μL) into the brain using a Hamilton syringe and microinjector (Stoelting). After injection, needle remained in place for an additional 2 min prior to retraction. Then a glass cranial window, made from 3 and 4 mm glass coverslips combined with optical glue, was carefully placed over the craniotomy with the smaller coverslip down, to cap the exposed brain in the skull opening. The window was stabilized, and affixed to the skull along with a stainless-steel head mount (Protoscience Solutions, Lexington, KY) using dental acrylic. Analgesic was injected subcutaneously, and animals recovered from anesthesia before return to their home cages.

Two photon microscopy. Mice were anesthetized and affixed to the imaging platform via a custom made fixture (Protoscience Solutions, Lexington, KY) on a Scientifica Hyperscope utilizing a tunable InSight X3 laser (Spectra-Physics), ranging from 680 to 1300 nm, and a 16×, 0.8 NA, 3 mm working distance objective lens (Nikon Instruments), and GaAsP photomultipliers (Hamamatsu Photonics). ScanImage acquisition software (MBF Biosciences) was used to drive microscope components and data acquisition from within MATLAB (MathWorks). Mice were aligned under the objective lens and received single retroorbital injections of rhodamine dextran dye (500 kDa, 5% w/v in saline) to visualize cerebral vasculature. A small air pump was gated by a solenoid control valve and connected to the vDAQ controlled through ScanImage. (MBF Biosciences). Anesthesia was removed, and imaging commenced once mice were fully alert and excitable by air puff stimulation (20 min or less).

Intravital Imaging of Vascular Dynamics and Astrocyte Ca²⁺ Signaling. Imaging sessions began by surveying the cranial surface for expression of GCaMP8f indicator. Once the field of view was selected, a baseline 5-minute recording of vascular and astrocyte activity was acquired followed by a series of timed whisker stimulation trials. Stimulation consisted of 10 second air puff trains (9 Hz) to the contralateral vibrissae, controlled by a custom software trigger integrated into the ScanImage software's frame clock. Videos were captured that contained several astrocytes, cerebral capillaries, and arterioles within the field of view. A minimum three minute interval separated stimulation trials. At the conclusion of the experiment, mice were then lightly anesthetized for removal from the imaging platform, and placed back into their home cages.

Image Analysis. Experimenters were blinded from genotype during all analyses, which were conducted using in-house Matlab algorithms described here. First, files containing time lapse videos (i.e., tifs) were motion corrected by the widely used NORMCORRE algorithm (24). Metadata containing scan speed, spatial dimensions, and stimulation timing were extracted for common use by analyses applications. Event based detection methods were used to identify astrocytes in the field of view (FOV). Further segmentation of astrocyte compartments such as soma and endfeet was accomplished through convolutional filtering and masking techniques that accentuate astrocyte features. For astrocyte endfeet, the perivascular space was masked prior to event based detection. In depth analyses of vascular motion and spatially paired astrocyte calcium signaling were characterized using our custom MATLAB-based application called LAVA.

Vascular motion was assessed by linearizing vessels of interest to better define spatial alignment between arteriole segments and endfeet compartment activity. Cross sectional vectors placed over arterioles of interest were used to determine cross sectional area and to sample fluorescence values of adjacent endfeet. The resulting “dataset” provides spatial-temporal information that can be used to quantify dynamic relationships between vascular tone, motion, and/or Ca²⁺ fluorescence, which, in turn, can offer insights into the directionality of vascular tone fluctuations and potential Ca²⁺ mediated changes. LAVA can also be used to correlate this activity in relation to other ROI segmentations (e.g. somata and capillary endfeet signals mentioned previously and not shown in this report), for predefined trial phases (i.e. before, during, and post-stimulation). The workflow for the application is as follows: In each FOV, dilating and contracting vessels-of-interest are identified and vessel boundaries are outlined. Vessels are then binarized and archived. The resulting data structure contains a total volume time series vector, and fully cross-sectioned and linearized vascular and Ca²⁺ channel image stacks. User defined perivascular ROIs are then identified from the linearized and scaled pseudo images of fluorescence changes along the vessel-of-interest. Results from vascular motion measurements are optionally used to update ROI positions for arteriole endfeet where vascular movement contaminates extracted Ca²⁺ signals. The application then extracts and saves the resulting time series vectors from these ROIs, and calculated maximum relative fluorescence changes. Correlations between endfeet Ca²⁺ signals and vascular activity are quantified by Pearson's r. Once ROI-based endfoot analyses are completed, LAVA conducts within vessel comparisons of fluorescence time series data and local vascular tone, by correlations within cross-sectional vectors.

Statistics. Most Ca²⁺ transient and vessel property parameters were compared across groups using unpaired student t-tests. Arteriole diameter changes before and during air puff stimulation were evaluated with repeated measure ANOVA, followed by simple effects tests. Correlations between time series data were determined by Pearson's r tests. Specifically, for network synchronicity analysis, events were cropped to only the rise phase of Ca²⁺ event transients before statistical analysis. Roughly equal numbers of males and females were used per genotype condition (WT: 5M & 6F, 5×FAD: 5M 9F). The total group numbers for animals were 11 WT and 14 5×FAD. At least two FOVs per mouse were used, and three replicate trials each for stimulation experiments.

Not all parameters could be cleanly measured from each mouse (e.g. interruption in imaging session, lack of identifiable arterioles, poor expression of Ca²⁺ indicator), resulting in exclusion from statistical analyses. Exclusion was performed before decoding of transgene groups. Unless, otherwise noted, statistical samples shown are average values obtained within each mouse. Significance for all statistical tests was set at p<0.05. For most parameters evaluated, there were no significant sex differences in either transgene group and so males and females were grouped together.

### Results

Spontaneous Ca²⁺ transients in 5×FAD mice are smaller, but occur more frequently in astrocyte somata and processes. Two photon imaging was used to assess astrocyte Ca²⁺ transients in barrel cortex of fully awake mice at a depth of 150-300 mm. Spontaneous Ca²⁺ transients were first assessed in the absence of movement across a 5 min time period, in which no external stimulation was administered. Regions of interest (ROIs) representing astrocyte somata and processes were segmented across the field of view (FOV) (FIG. 1A-D) and a convolution-based event detection technique was used to detect significant events over baseline Ca²⁺ levels. Ca²⁺ transients (DF/F) in representative ROIs from a single FOV in a WT and 5×FAD mouse are shown in FIG. 1E. Ca²⁺ transients in both cellular compartments occurred more frequently in 5×FAD mice, especially in astrocyte processes (FIG. 1F somata, p=0.06; FIG. 1K processes, p=0.02). However, transient amplitudes in 5×FAD astrocytes were also smaller (FIG. 1G somata, p=0.03; FIG. 1L processes, p=0.03) with trending reductions in area under the curve (AUC) measures (FIG. 1I somata, p=0.05; FIG. 1N processes, p=0.07). No differences in rise time properties were observed (FIGS. 1H and 1M), but transient decay was accelerated in the 5×FAD group (FIG. 1J somata, p=0.02; FIG. 10 processes, p=0.03).

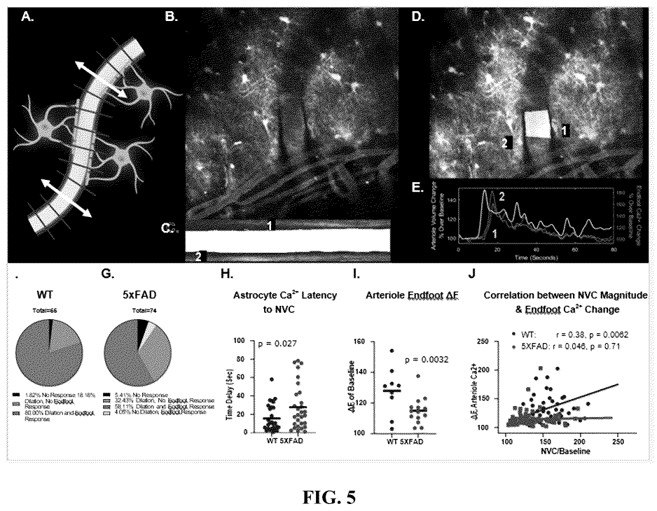

Evoked dilations in penetrating arterioles are reduced in 5×FAD mice. Functional hyperemia, as assessed by stimulus-evoked cerebral vessel dilations or increased blood flow is impaired in multiple AD/ADRD rodent models including 5×FAD mice, when assessed under general anesthesia (25). To determine if similar deficits occur in fully awake 5×FAD mice, we delivered air puffs (9 Hz, 10 sec) to contralateral vibrissae and measured hyperemic responses in penetrating arterioles of the barrel cortex (FIG. 2A-D). Vessels of interest were identified and cross-sectioned to generate a linearized vessel model (FIG. 2E, and see FIG. 5A-C). Representative two photon images show penetrating arterioles before (FIG. 2B) and during (FIG. 2C, D) the air puff, while representative time plots illustrate differences in arteriole dilation across WT and 5×FAD mice (FIG. 2F). Before-and-after (air puff) scatterplots are shown in FIG. 2G and differences determined by repeated measures 2-way ANOVA. No genotype differences were observed for resting (prestimulation) arteriole tone (FIG. 2G, round plot symbols). But, while air puff stimulation led to increased arteriole cross sectional area in all animals [Baseline vs. Stimulation F (1,24)=69.3, p<0.001], this increase was significantly smaller in 5×FAD mice (Interaction: F (1,24)=5.097, p=0.033, & FIG. 2H, p=0.002), indicative of a neurovascular coupling deficit.

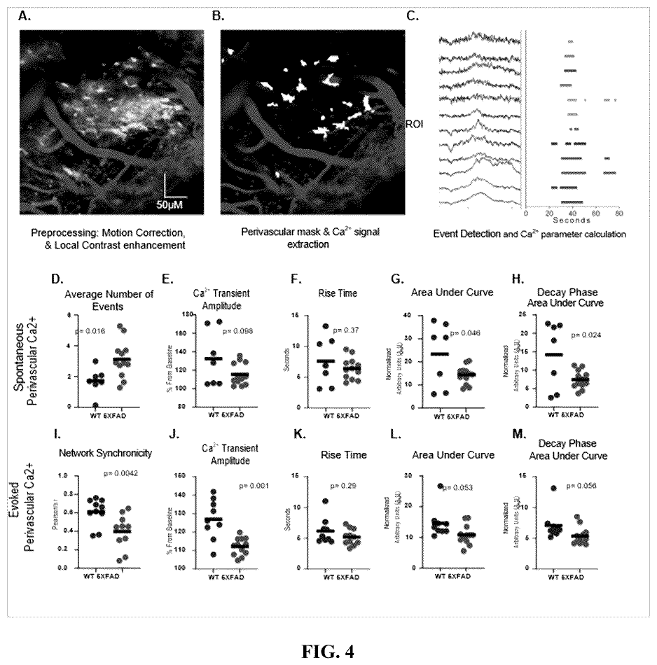

Evoked Ca²⁺ activity in astrocytes is impaired in individual cell compartments and across multicell networks in 5×FAD mice. Air puff stimulation led to a large population Ca²⁺ response across astrocytes in the FOV, with highly correlated activity observed in both WT and 5×FAD mice (see FIG. 3). FIG. 3A shows representative extracted Ca²⁺ traces from each ROI in a FOV during a whisker stimulation trial. Ca²⁺ transient kinetics were very similar and synchronous across some ROIs (indicated by asterisks in linearized traces, FIG. 3B), while Ca²⁺ transients in other ROIs showed dissimilar kinetics (indicated by pound symbols in linearized traces, FIG. 3B). FIG. 3C shows representative astrocyte network responses in a WT and 5×FAD mouse with overlaid correlograms. Lines connect co-active ROIs. Line color indicates the degree of synchronicity between each ROI pair (red-yellow is high; blue is low, Pearson's r). Assessment of population responses in astrocyte networks showed reduced synchronicity in the 5×FAD group, especially in astrocyte processes (FIG. 3D, somata p=0.01; FIG. 3I, processes p=0.007 n=9,13). In addition to network-wide Ca²⁺ responses, we also assessed evoked Ca²⁺ transient parameters from individual cell compartments (somata, FIG. 3E-3H; processes, FIG. 3J-3M). Individual Ca²⁺ transients were reduced in amplitude in 5×FAD mice (somata, p=0.002, FIG. 3E; processes, p=0.01, FIG. 3J), along with trends for reduced AUC measures (somata, p=0.11, FIG. 3G; processes p=0.08, FIG. 3L). The decay time for evoked Ca²⁺ responses was accelerated in the 5×FAD group, especially in astrocyte processes (somata, p=0.08, FIG. 3H; processes, p=0.03, FIG. 3M). No changes in rise time for evoked transients were observed (FIG. 3F, 3K). The results show that evoked astrocyte activity, as assessed in individual subcompartments and across astrocyte networks, is impaired in 5×FAD mice.

Changes in perivascular Ca²⁺ signaling in 5×FAD mice. We next assessed perivascular astrocyte Ca²⁺ signaling dynamics, specifically. This entailed activity in the immediate vicinity of all cerebral vessels (arterioles, venules, capillaries) and was enriched for astrocyte endfeet and distal astrocyte process compartments (FIG. 4). Representative masking and segmentation steps are shown in FIGS. 4A and B. Representative activity from multiple perivascular ROIs in the FOV is shown in FIG. 4C. In the absence of air puff, spontaneous events occurred in 5×FADs at a higher rate, relative to WTs (FIG. 4D, p=0.02), but tended to be smaller in amplitude (FIG. 4E, p=0.1) and integrated area (FIG. 4G p=0.05), with accelerated decay (FIG. 4H, p=0.02). During air puff stimulation trials, population responses in perivascular regions showed reduced synchronicity in 5×FAD mice (FIG. 4I, p=0.004). Evoked Ca²⁺ transients in perivascular spaces were also smaller in amplitude (FIG. 4J, p=0.001) and integrated area (FIG. 4L, p=0.05), and tended to decay more rapidly (FIG. 4M, p=0.06) in 5×FADs relative to WTs.

Reduced signaling fidelity between astrocyte endfeet and arterioles in 5×FAD mice. To investigate dynamic interactions specifically between cerebral arterioles (see FIG. 2) and astrocyte endfeet we used a custom MATLAB-based application called LAVA (FIG. 5). Analyses were restricted to endfeet pairings with cerebral arterioles because of the relative difficulty of observing/measuring dilations in veins/venules and capillaries. FIG. 5A shows a cartoon illustration of arteriole segments demarcated by blue lines along with adjacent astrocyte endfeet. Arrows indicate expansion/constriction of vessel diameter with air puff stimulation. FIG. 5B shows a two photon micrograph of an arteriole (red) and summated astrocyte Ca²⁺ activity (green) in the FOV. Arterioles of interest are binarized and linearized (FIG. 5C) and immediately adjacent perivascular Ca²⁺ events (1 and 2, shown in green on either side of linearized vessel) are extracted and mapped back to the raw channels (FIG. 5D, vessel segment shown in white, adjacent endfeet compartments 1 and 2 shown in fuchsia). Figure E shows the temporal relationships between vasoactive responses observed in the arteriole segment and immediately adjacent astrocyte endfeet shown in FIG. 5D. In nearly all arteriole endfeet pairings, Ca²⁺ changes in astrocyte endfeet lagged behind arteriole dilations. A total of 55 and 74 endfeet-arteriole segment pairings were evaluated in the barrel cortex of 10 WT and 13 5×FAD mice, respectively (FIG. 5F, 5G). For the WT group, Ca²⁺ transients occurred in 80% of the endfeet in response to a stimulation-induced dilation of the immediately adjacent arteriole segment (FIG. 5F). For approximately 18% of the endfeet-arteriole pairings in the WT group, dilations occurred in the absence of Ca²⁺ transients, while in roughly 2% of the pairings there was neither a dilation, nor a Ca²⁺ change (FIG. 5F). In contrast to WT mice, an evoked Ca²⁺ transient was observed in only 58% of the endfeet-arteriole pairings in the 5×FAD group (FIG. 5G). In 32% of the pairings, arteriole dilations occurred in the absence of an endfoot Ca²⁺ transient, while approximately 4% the pairings showed an endfoot Ca²⁺ response in the absence of an arteriole dilation (FIG. 5F). The remaining pairings (5.41%) in the 5×FAD group showed neither a dilation nor a Ca²⁺ change. In 5×FAD pairings where there was co-activity, endfeet Ca²⁺ transients emerged more slowly after local arteriole dilations (FIG. 5H, p=0.027) and were smaller in amplitude (FIG. 5I, p=0.003). We next investigated whether Ca²⁺ changes in astrocyte endfeet were proportional to the magnitude of the arteriole dilation (FIG. 5J). For WT mice, endfeet Ca²⁺ transient amplitudes were positively correlated to dilation magnitudes observed in immediately adjacent arterioles (r=0.38, p=0.0062). In contrast, we observed no correlation between arteriole dilation magnitudes and endfeet Ca²⁺ changes in 5×FAD mice (r=0.046, p=0.71; 5×FAD vs. WT, z=1.851, p=0.032). Together, these results suggest that endfeet Ca²⁺ signaling is relatively uncoupled from local arteriole activity in 5×FAD vs. WT mice.

Summarizing, using the disclosed machine learning-based methodologies described above Applicants have investigated astrocyte Ca²⁺ signaling in conjunction with arteriole dilatory responses in an intact, and fully awake, mouse model. To Applicant's knowledge this is the first study of Alzheimer's Disease in an intact, fully awake mouse model.

The overall results demonstrate signs of spontaneous hyperactivity in reactive astrocytes of 5×FAD mice, consistent with other reports. In contrast, evoked Ca²⁺ activity in 5×FAD mice was impaired in individual astrocyte compartments and also across astrocyte networks. Most strikingly, we found that astrocyte endfeet Ca²⁺ signaling in 5×FAD mice is largely uncoupled from local arteriole dilations, which could have important implications for brain metabolism during the progression of AD-related pathology. The results underscore the sensitivity of astrocyte endfeet to developing pathological conditions, like AD, and suggest that these cellular specializations may offer modifiable targets for improving blood flow, metabolism, and overall brain health.

In human brains with abundant AD neuropathology (A plaques and neurofibrillary tangles), there have been reports of comorbid cerebral small vessel pathologies other than cerebral amyloid angiopathy, as well as in vivo neuroimaging abnormalities (e.g. white matter abnormalities and vascular flow perturbations) indicative of small vessel disease (SVD) (26-34). These observations imply the existence of pathogenetic synergies between AD-type neuropathology and SVD that go well beyond amyloid angiopathy, and which may relate to dysfunction of astrocytes. Ca²⁺ signaling in astrocytes has been linked to numerous processes including the modulation of transmembrane K⁺ channels, release of gliotransmitters, cytoskeletal remodeling/degeneration, and gene expression to name a few (35-38). All of these processes appear to be altered in neurodegenerative conditions (6, 39-41). Moreover, targeted inhibition of hyperactive Ca²⁺-signaling pathways in astrocytes ameliorates multiple pathophysiologic outcomes in intact AD/ADRD mouse models (12, 42, 43), suggesting a central role for astrocytic Ca²⁺ abnormalities in chronic neurodegenerative conditions.

Similar to previous reports (15, 17-19, 49, 52), 5×FAD mice exhibited an increase in the frequency of spontaneous Ca²⁺ transients across cellular compartments, suggesting that reactive astrocytes are somewhat hyperactive. Increased rates of Ca²⁺ activity may explain why Ca²⁺-dependent pathways, like calcineurin/NFAT, show aberrantly high activity/expression in reactive astrocytes (43, 44, 53, 54). The source of Ca²⁺ hyperactivity may be an intrinsic property of astrocytes, as previous studies observed greater Ca²⁺ transient frequency in APP/PS1 transgenic mice even when neuronal activity was independently suppressed (18). While astrocytes in 5×FADs appeared spontaneously hyperactive, evoked responses were impaired at the network level and also at the levels of individual cellular compartments. In both transgene groups, whisker stimulation elicited robust astrocytic Ca²⁺ responses that were highly correlated across multiple cells in the field of view. However, correlated activity in 5×FAD mice was significantly lower compared to WTs, perhaps because of gap junction abnormalities that disrupt electrotonic coupling across astrocyte networks (55). Reductions in evoked Ca²⁺ transient amplitudes in 5×FAD mice were also observed in astrocyte somata, processes, and endfeet, similar to what others have reported (15, 47).

Not previously reported to Applicant's knowledge, the present studies demonstrated that astrocyte endfeet in 5×FAD mice responded to penetrating arteriole dilations with poor fidelity. To evaluate concurrent cerebral vessel and astrocyte endfeet activity, we developed a custom MATLAB based application called LAVA. The application is unique in its versatility for analyzing otherwise challenging video files. Its preprocessing options for motion correction, filtering, dissection by trial phases, and adaptive ROI identification allow for precise assessment of vascular tone and proximal Ca²⁺ signals, even for narrow, moving endfeet exhibiting small Ca²⁺ signals. In addition, LAVA enables comparison of its outputs to existing ROI signal analysis. Perhaps the biggest advantage of LAVA is that it can determine the temporal and proportional properties of perivascular Ca²⁺ signals in relation to the activity of immediately adjacent vessel segments. This capability is particularly useful for defining the directional nature of signaling within the neurovascular unit. For instance, under the conditions employed here, we found that evoked Ca²⁺ transients in astrocyte endfeet almost always followed the dilation of local arterioles (FIG. 5). These observations are similar to earlier work on fully awake mice during air-puff whisker stimulation, or stimulation from natural whisking during locomotor activity (56, 57). While we cannot rule out the possibility that faster events at astrocyte endfeet (e.g. transmembrane K⁺ fluxes) contribute to rapid vessel dilations, the LAVA analyses conducted here, in combination with the use of the most sensitive GCaMP available (jGCaMP8f), suggests that astrocyte Ca²⁺ signaling does not initiate local arteriole dilations.

Regardless of whether astrocytes trigger dilation, our work suggests that reactive astrocytes in 5×FAD mice do not respond to arteriole dilations with the same fidelity seen in WT counterparts. Ca²⁺ transients in 5×FAD endfeet occurred only 58% of the time in response to local arteriole dilations (vs 80% in WT mice), with a lag time of about 30 sec (vs. 17 sec in WTs). While 5×FAD mice also exhibited smaller evoked arteriole dilations, it's unlikely this deficit was the primary cause of impaired endfeet Ca²⁺ signaling. In fact, we found no correlation between the magnitude of vessel dilation and endfeet Ca²⁺ transient amplitude in 5×FAD mice (unlike WTs, which did exhibit proportionality between arteriole and endfeet responses). Together, these results suggest that astrocytes, a major metabolic hub in the brain, respond sluggishly and disproportionately in 5×FAD mice to the most important mechanism for delivering energy on demand (i.e. functional hyperemia).

It will be understood that various details of the presently disclosed subject matter can be changed without departing from the scope of the subject matter disclosed herein. Furthermore, the foregoing description is for the purpose of illustration only, and not for the purpose of limitation. Obvious modifications and variations are possible in light of the above teachings. All such modifications and variations are within the scope of the appended claims when interpreted in accordance with the breadth to which they are fairly, legally and equitably entitled.

### REFERENCES

1. S. Schaeffer, C. Iadecola, Revisiting the neurovascular unit. Nat Neurosci 24, 1198-1209 (2021).
2. C. Iadecola, The Neurovascular Unit Coming of Age: A Journey through Neurovascular Coupling in Health and Disease. Neuron 96, 17-42 (2017).
3. D. P. Veitch et al., Understanding disease progression and improving Alzheimer's disease clinical trials: Recent highlights from the Alzheimer's Disease Neuroimaging Initiative. Alzheimers Dement 15, 106-152 (2019).
4. A. Pivoriunas, A. Verkhratsky, Astrocyte-Endotheliocyte Axis in the Regulation of the Blood-Brain Barrier. Neurochem Res 46, 2538-2550 (2021).
5. A. Verkhratsky, M. Nedergaard, Astroglial cradle in the life of the synapse. Philos Trans R Soc Lond B Biol Sci 369, 20130595 (2014).
6. B. R. Price, L. A. Johnson, C. M. Norris, Reactive astrocytes: The nexus of pathological and clinical hallmarks of Alzheimer's disease. Ageing Res Rev 68, 101335 (2021).
7. C. Escartin et al., Reactive astrocyte nomenclature, definitions, and future directions. Nat Neurosci 24, 312-325 (2021).
8. S. A. Liddelow, M. L. Olsen, M. V. Sofroniew, Reactive Astrocytes and Emerging Roles in Central Nervous System (CNS) Disorders. Cold Spring Harb Perspect Biol 16 (2024).
9. T. L. Stackhouse, A. Mishra, Neurovascular Coupling in Development and Disease: Focus on Astrocytes. Front Cell Dev Biol 9, 702832 (2021).
10. S. Takahashi, Metabolic Contribution and Cerebral Blood Flow Regulation by Astrocytes in the Neurovascular Unit. Cells 11 (2022).
11. E. Beard, S. Lengacher, S. Dias, P. J. Magistretti, C. Finsterwald, Astrocytes as Key Regulators of Brain Energy Metabolism: New Therapeutic Perspectives. Front Physiol 12, 825816 (2021).
12. P. Sompol et al., Targeting Astrocyte Signaling Alleviates Cerebrovascular and Synaptic Function Deficits in a Diet-Based Mouse Model of Small Cerebral Vessel Disease. J Neurosci 43, 1797-1813 (2023).
13. P. Kelly et al., Neuronally Derived Soluble Abeta Evokes Cell-Wide Astrocytic Calcium Dysregulation in Absence of Amyloid Plaques in Vivo. J Neurosci 43, 4926-4940 (2023).
14. Y. F. Lee et al., Optogenetic targeting of astrocytes restores slow brain rhythm function and slows Alzheimer's disease pathology. Sci Rep 13, 13075 (2023).
15. J. Lines et al., Astrocyte-neuronal network interplay is disrupted in Alzheimer's disease mice. Glia 70, 368-378 (2022).
16. D. Shah et al., Astrocyte calcium dysfunction causes early network hyperactivity in Alzheimer's disease. Cell Rep 40, 111280 (2022).
17. A. Delekate et al., Metabotropic P2Y1 receptor signalling mediates astrocytic hyperactivity in vivo in an Alzheimer's disease mouse model. Nat Commun 5, 5422 (2014).
18. K. V. Kuchibhotla, C. R. Lattarulo, B. T. Hyman, B. J. Bacskai, Synchronous hyperactivity and intercellular calcium waves in astrocytes in Alzheimer mice. Science 323, 1211-1215 (2009).
19. T. Takano, X. Han, R. Deane, B. Zlokovic, M. Nedergaard, Two-photon imaging of astrocytic Ca²⁺ signaling and the microvasculature in experimental mice models of Alzheimer's disease. Ann N Y Acad Sci 1097, 40-50 (2007).
20. Y. R. Gao et al., Time to wake up: Studying neurovascular coupling and brain-wide circuit function in the un-anesthetized animal. Neuroimage 153, 382-398 (2017).
21. A. S. Thrane et al., General anesthesia selectively disrupts astrocyte calcium signaling in the awake mouse cortex. Proc Natl Acad Sci USA 109, 18974-18979 (2012).
22. O. Tran, H. J. Hughes, T. Carter, K. Torok, Development and characterization of novel jGCaMP8f calcium sensor variants with improved kinetics and fluorescence response range. Front Cell Neurosci 17, 1155406 (2023).
23. S. L. Case, R. L. Lin, O. Thibault, Age- and sex-dependent alterations in primary somatosensory cortex neuronal calcium network dynamics during locomotion. Aging Cell 22, e13898 (2023).
24. E. A. Pnevmatikakis, A. Giovannucci, NoRMCorre: An online algorithm for piecewise rigid motion correction of calcium imaging data. Journal of Neuroscience Methods 291, 83-94 (2017).
25. A. Mughal, O. F. Harraz, A. L. Gonzales, D. Hill-Eubanks, M. T. Nelson, PIP (2) Improves Cerebral Blood Flow in a Mouse Model of Alzheimer's Disease. Function (Oxf) 2, zqab010 (2021).
26. R. Koncz, P. S. Sachdev, Are the brain's vascular and Alzheimer pathologies additive or interactive? Curr Opin Psychiatry 31, 147-152 (2018).
27. D. G. Ali et al., White matter hyperintensities influence distal cortical beta-amyloid accumulation in default mode network pathways. Brain Behav 13, e3209 (2023).
28. M. Wu et al., In Pre-Clinical AD Small Vessel Disease is Associated With Altered Hippocampal Connectivity and Atrophy. Am J Geriatr Psychiatry 31, 112-123 (2023).
29. S. Hilal et al., Plasma Amyloid-beta Levels, Cerebral Small Vessel Disease, and Cognition: The Rotterdam Study. J Alzheimers Dis 60, 977-987 (2017).
30. N. C. Edwards et al., Cerebrovascular disease is associated with Alzheimer's plasma biomarker concentrations in adults with Down syndrome. Brain Commun 6, fcae331 (2024).
31. J. Zhang et al., Linking white matter hyperintensities to regional cortical thinning, amyloid deposition, and synaptic density loss in Alzheimer's disease. Alzheimers Dement 20, 3931-3942 (2024).
32. Y. Song, H. Xing, Z. Zhang, Microvascular Perfusion Imaging in Alzheimer's Disease. J Integr Neurosci 23, 70 (2024).
33. C. G. Swinford et al., Amyloid and tau pathology are associated with cerebral blood flow in a mixed sample of nondemented older adults with and without vascular risk factors for Alzheimer's disease. Neurobiol Aging 130, 103-113 (2023).
34. P. Abbrescia et al., Crucial role of Aquaporin-4 extended isoform in brain water Homeostasis and Amyloid-beta clearance: implications for Edema and neurodegenerative diseases. Acta Neuropathol Commun 12, 159 (2024).
35. P. Sompol, C. M. Norris, Ca⁽²⁺⁾, Astrocyte Activation and Calcineurin/NFAT Signaling in Age-Related Neurodegenerative Diseases. Front Aging Neurosci 10, 199 (2018).
36. D. Lim, A. Semyanov, A. Genazzani, A. Verkhratsky, Calcium signaling in neuroglia. Int Rev Cell Mol Biol 362, 1-53 (2021).
37. A. Verkhratsky, Astroglial Calcium Signaling in Aging and Alzheimer's Disease. Cold Spring Harb Perspect Biol 11 (2019).
38. S. V. Straub, M. T. Nelson, Astrocytic calcium signaling: the information currency coupling neuronal activity to the cerebral microcirculation. Trends Cardiovasc Med 17, 183-190 (2007).
39. J. A. Orellana et al., Amyloid beta-induced death in neurons involves glial and neuronal hemichannels. J Neurosci 31, 4962-4977 (2011).
40. A. Bellot-Saez, O. Kekesi, J. W. Morley, Y. Buskila, Astrocytic modulation of neuronal excitability through K (+) spatial buffering. Neurosci Biobehav Rev 77, 87-97 (2017).
41. M. Olabarria, H. N. Noristani, A. Verkhratsky, J. J. Rodriguez, Concomitant astroglial atrophy and astrogliosis in a triple transgenic animal model of Alzheimer's disease. Glia 58, 831-838 (2010).
42. J. L. Furman et al., Targeting astrocytes ameliorates neurologic changes in a mouse model of Alzheimer's disease. J Neurosci 32, 16129-16140 (2012).
43. P. Sompol et al., Calcineurin/NFAT Signaling in Activated Astrocytes Drives Network Hyperexcitability in Abeta-Bearing Mice. J Neurosci 37, 6132-6148 (2017).
44. D. Lim et al., Amyloid beta deregulates astroglial mGluR5-mediated calcium signaling via calcineurin and Nf-KB. Glia 61, 1134-1145 (2013).
45. E. V. Mitroshina et al., Novel Algorithm of Network Calcium Dynamics Analysis for Studying the Role of Astrocytes in Neuronal Activity in Alzheimer's Disease Models. Int J Mol Sci 23 (2022).
46. V. Ronco et al., Differential deregulation of astrocytic calcium signalling by amyloid-beta, TNFalpha, IL-1beta and LPS. Cell Calcium 55, 219-229 (2014).
47. M. Abghari, J. Vu, N. Eckberg, B. I. Aldana, K. A. Kohlmeier, Decanoic Acid Rescues Differences in AMPA-Mediated Calcium Rises in Hippocampal CA1 Astrocytes and Neurons in the 5×FAD Mouse Model of Alzheimer's Disease. Biomolecules 13 (2023).
48. A. Paumier et al., Astrocyte-neuron interplay is critical for Alzheimer's disease pathogenesis and is rescued by TRPA1 channel blockade. Brain 145, 388-405 (2022).
49. C. F. M. Huffels, L. M. Osborn, N. L. M. Cappaert, E. M. Hol, Calcium signaling in individual APP/PS1 mouse dentate gyrus astrocytes increases ex vivo with Abeta pathology and age without affecting astrocyte network activity. J Neurosci Res 100, 1281-1295 (2022).
50. T. Takano et al., Rapid manifestation of reactive astrogliosis in acute hippocampal brain slices. Glia 62, 78-95 (2014).
51. S. C. Lange, L. K. Bak, H. S. Waagepetersen, A. Schousboe, M. D. Norenberg, Primary cultures of astrocytes: their value in understanding astrocytes in health and disease. Neurochem Res 37, 2569-2588 (2012).
52. K. S. Åbjørsbråten et al., Impaired astrocytic Ca²⁺ signaling in awake-behaving Alzheimer's disease transgenic mice. eLife 11, e75055 (2022).
53. M. M. Pleiss et al., Calcineurin proteolysis in astrocytes: Implications for impaired synaptic function. Biochim Biophys Acta 1862, 1521-1532 (2016).
54. S. D. Kraner et al., Development of a monoclonal antibody specific for a calpain-generated 48 kDa calcineurin fragment, a marker of distressed astrocytes. J Neurosci Methods 402, 110012 (2024).
55. A. Semyanov, Spatiotemporal pattern of calcium activity in astrocytic network. Cell Calcium 78, 15-25 (2019).
56. C. H. T. Tran, G. Peringod, G. R. Gordon, Astrocytes Integrate Behavioral State and Vascular Signals during Functional Hyperemia. Neuron 100, 1133-1148 e1133 (2018).
57. A. P. Del Franco, P. P. Chiang, E. A. Newman, Dilation of cortical capillaries is not related to astrocyte calcium signaling. Glia 70, 508-521 (2022).
58. C. Chen et al., Early impairment of cortical circuit plasticity and connectivity in the 5×FAD Alzheimer's disease mouse model. Transl Psychiatry 12, 371 (2022).
59. S. Forner et al., Systematic phenotyping and characterization of the 5×FAD mouse model of Alzheimer's disease. Sci Data 8, 270 (2021).
60. D. M. Wilcock, M. P. Vitek, C. A. Colton, Vascular amyloid alters astrocytic water and potassium channels in mouse models and humans with Alzheimer's disease. Neuroscience 159, 1055-1069 (2009).
61. T. L. Sudduth et al., Time-course of glial changes in the hyperhomocysteinemia model of vascular cognitive impairment and dementia (VCID). Neuroscience 341, 42-51 (2017).
62. M. I. Okoye, I. Watanabe, Ultrastructural features of cerebral amyloid angiopathy. Hum Pathol 13, 1127-1132 (1982).
63. C. A. Hawkes et al., Stroke-induced opposite and age-dependent changes of vessel-associated markers in co-morbid transgenic mice with Alzheimer-like alterations. Exp Neurol 250, 270-281 (2013).
64. I. F. Kimbrough, S. Robel, E. D. Roberson, H. Sontheimer, Vascular amyloidosis impairs the gliovascular unit in a mouse model of Alzheimer's disease. Brain 138, 3716-3733 (2015).
65. J. N. Haidey et al., Astrocytes regulate ultra-slow arteriole oscillations via stretch-mediated TRPV4-COX-1 feedback. Cell Rep 36, 109405 (2021).
66. K. J. Kim et al., Astrocyte contributions to flow/pressure-evoked parenchymal arteriole vasoconstriction. J Neurosci 35, 8245-8257 (2015).

What is claimed:

1. A method, comprising:
capturing a digital video of cellular structure and/or motion in one or more fields of view;
digitally filtering the video to accentuate cell features, eliminate Poisson noise, and correct unevenly illuminated fields of view;
identifying one or more regions of interest (ROI) in the one or more digitally filtered fields of view by a masking process comprising inputting normalized time series vectors and calculated signal parameters into a principal component analysis (PCA) to identify one or more PCA features;
clustering the identified PCA features to provide one or more activity clusters and selecting one or more of the activity clusters showing an activity of interest;
parsing the one or more selected activity clusters into pixel groupings by identifying connected pixels;
averaging time series data for the selected pixel groupings and inputting the averaged time series data into a signal analysis routine to provide one or more ROI signals;
processing the one or more ROI signals by:
a continuous wavelet transformation and convolutional filtering; and
determining a cell activity vector.

2. The method of claim 1, further comprising detecting an event of interest by mirror padding the processed one or more ROI signals at signal start and end points, filtering the mirror padded one or more ROI signals, removing the mirror padded ends of the processed and filtered one or more ROI signals, inverting the signals, and acquiring local maximum and minimum signal amplitudes to index event peaks and signal start and end indices.

3. The method of claim 1, further comprising applying another imaging channel to restrict signal clustering to an index of a channel of interest and surrounding space.

4. The method of claim 3, further including setting boundaries of the channel of interest and modeling the boundaries using piecewise cubic hermite interpolating polynomials (PCHIP); and
defining one or more perpendicular line functions to provide a plurality of images of the channel of interest cross-section.

5. The method of claim 4, further including creating a binary mask of the channel of interest by adaptive thresholding.

6. A method, comprising:
capturing a digital video of cellular structure and/or motion in one or more fields of view; and
digitally filtering the digital video to accentuate cell features, eliminate Poisson noise, and correct unevenly illuminated fields of view by:
obtaining a motion signal associated with a time-series image dataset extracted from the digital video;
thresholding the motion signal to identify one or more motion-associated time points;
converting the thresholded motion signal to provide a binary motion trace;
expanding each motion-associated time point over a predetermined temporal window defined by a selected number of digital video frames to provide one or more continuous motion associated time indices;
storing the one or more expanded motion-associated time indices as a motion index; and
using the motion index to identify and/or exclude detected events that overlap motion-associated frames of the digital video frames to provide one or more uncontaminated motion-associated frames of the digital video.

7. The method of claim 6, further comprising detecting cellular events by generating an event map from the one or more uncontaminated motion-associated frames of the digital video.

8. The method of claim 7, further comprising conditioning the one or more uncontaminated motion-associated frames of the digital video by identifying one or more candidate signaling events from the event map by a multi-scale temporal detection process.

9. The method of claim 8, wherein the multi-scale temporal detection process comprises applying one or more of temporal filters, convolution kernels, wavelets, or matched filters to the event map.

10. The method of claim 9, wherein the multi-scale temporal detection process identifies one or more candidate signaling events having a distinctive temporal profile including one or more of a distinct rise time, a distinct decay time, a distinct full-width duration, a distinct onset slope, and a distinct transient shape.

11. The method of claim 10, wherein the event map represents one of the group consisting of: an event-likelihood trace, a convolution-derived response trace, a filtered response trace, and a time-dependent representation indicting a likelihood that a physiological event is present at each time point.

12. The method of claim 7, further comprising steps of signal analysis and pixel pre-classification to provide cell masks.

13. The method of claim 12, wherein the signal analysis and pixel pre-classification comprises inputting one or more normalized time series vectors and calculated signal parameters to provide a signal comprising a region-specific time-dependent trace identifying one or more regions of interest (ROI).

14. The method of claim 12, further wherein the one or more normalized time series vectors and calculated signal parameters are input into a principal component analysis (PCA) to identify one or more PCA features.

15. The method of claim 14, further wherein the one or more identified PCT features are clustered to provide one or more activity clusters.

16. The method of claim 15, further wherein one or more of the activity clusters showing an activity of interest are selected and parsed into pixel groupings by identifying connected pixels.

17. The method of claim 16, further wherein averaged time series data of the selected and parsed pixel groupings are input into a signal analysis routine to provide one or more ROI signals.

18. The method of claim 17, further wherein the one or more ROI signals are processed by a continuous wavelet transformation and convolutional filtering.

19. The method of claim 18, further including determining a cell activity vector.

20. The method of claim 19, wherein the cell activity vector is calculated as:
$${\sum }_{i = 1}^{n} w {t ( i , : )}_{smoothed} * y ( i )$$
where:
n=number of convolutions;
wt=Wavelet Transform Matrix;
y=number of convolution outputs; and
i=event frequency iterator.
